(19) United States
(12) Patent Application Publication
(10) Pub. No.: US 2025/0375723 A1
(43) Pub. Date: Dec. 11, 2025

(54) FLUID STRAINER

(71) Applicant: Paul F. Nehlen, III, Delavan, WI (US)

(72) Inventor: Paul F. Nehlen, III, Delavan, WI (US)

(73) Assignee: Blue Skies Global LLC, Williams Bay, WI (US)

(21) Appl. No.: 19/307,714

(22) Filed: Aug. 22, 2025

Related U.S. Application Data
(63) Continuation-in-part of application No. 18/389,978, filed on Dec. 20, 2023.
(60) Provisional application No. 63/435,018, filed on Dec. 23, 2022.

(51) Int. Cl. B01D 36/02; B01D 24/10; B01D 29/13; B01D 35/26; C02F 1/00

(52) U.S. Cl. CPC B01D 36/02; B01D 24/10; B01D 29/13; B01D 35/26; C02F 1/001; B01D 2101/00; C02F 2303/16

(57) ABSTRACT

A fluid strainer that is meant to remove debris from the flow of fluid through a strainer and that includes a housing having inlet and outlet ports. The housing defines an interior chamber through which the fluid flows. The fluid strainer including a single strainer basked disposed within the housing chamber. The strainer basket has open input end into which the fluid flows from the housing inlet and opposed side walls that extend in the direction of the fluid. The strainer basked further includes an open output end that is comprised of a pair of tapered output wall that direct the fluid flow to the housing outlet port. The strainer housing also includes a side inlet pipe for receiving filtration media.

### CROSS-REFERENCE TO RELATED APPLICATIONS

This application is a continuation-in-part (CIP) of U.S. Ser. No. 18/389,978 which was filed on Dec. 20, 2023 and which claims priority to U.S. Provisional Patent Application No. 63/435,018 which was filed on Dec. 23, 2022 and each of which is incorporated by reference herein in its entirety. U.S. Pat. No. 11,065,566 issued Jul. 20, 2021 is also incorporated herein by reference in its entirety.

### TECHNICAL FIELD

The present invention relates in general to a fluid strainer which is typically used for removing and straining suspended substances from a fluid flow. More particularly, the present invention relates to a fluid strainer that more effectively controls the flow and minimizes turbulence within the strainer device; and thus within the entire filter system.

### BACKGROUND OF THE INVENTION

Existing strainer devices are considered as having certain drawbacks. For one thing, they are generally assembled using several bolts; typically in excess of 20 bolts. Each time that the strainer is to be serviced, this requires the unfastening and refastening of the strainer housing cover. This is a time-consuming step in order to service the strainer. As a result, many times the strainer chamber does not get emptied often enough. This can lead to system failures including excessive back pressure. Another problem associated with existing strainers is that they do not provide an effective flow path through the strainer and thus are subject to unwarranted turbulence.

Accordingly, it is an object of the present invention to provide an improved strainer construction that eliminates the need for multiple fasteners to secure the cover of the strainer housing.

Another object of the present invention is to provide an improved strainer that enhances the flow of fluid through the strainer thus minimizing turbulence.

Still another object of the present invention is to provide an improved strainer that relies upon pneumatic pressure for sealing a lid or cover to the strainer housing.

### SUMMARY OF THE INVENTION

In accordance with the present invention there is provided a fluid strainer that is meant to remove debris from a fluid stream. The fluid strainer is comprised of a housing having an inlet port and an outlet port that is in a position that is generally opposite to the inlet port. The housing defines an interior chamber through which the fluid flows. The fluid strainer of the present invention includes preferably a single strainer basket that is disposed within the housing chamber. The strainer basket has an open input end into which the fluid flows from the housing inlet, and opposed sidewalls that extend generally in a flow direction of the fluid. The strainer basked further includes an open output end that is comprised of a pair of tapered outlet walls that direct the fluid flow to the housing outlet port. This flow is substantially unimpeded and provides a smooth transition of the fluid to the housing outlet port.

In accordance with other aspects of the present invention the basket further includes an end wall; the end wall has a series of through holes for the passage of fluid flow; the tapered outlet walls also each include a series of holes; the end wall is smaller than the outlet port in the housing; the end wall is the same size as the outlet port in the housing; the end wall is greater than the outlet port in the housing; the tapered outlet walls progress from a wider cross-section to a narrower cross-section; the inlet port is inline with the outlet port; the opposed sidewalls are solid and thus re-direct the fluid flow toward the end wall of the basket; including a lid that is disposed over the housing and covering the interior chamber and a gasket that is disposed between the housing and the lid; further including a pneumatic apparatus coupled to the interior chamber to provide a firm seal at the gasket; further including a mechanical interlock mechanism so that the lid is secured to the housing, and wherein the interlock mechanism is operable followed by the operation of the pneumatic apparatus; the mechanical interlock mechanism includes a tab and slot arrangement; the tab and slot arrangement comprises at least one tab on an underside of the lid and at least one slot in the housing; including a catcher that is meant to intercept certain items; particularly larger size items; and wherein the catcher is of cross-shape and is disposed at the open input end of the strainer basket.

In accordance with the present invention there is also provided a fluid strainer that is meant to remove debris from a fluid stream, comprising: a housing having an inlet port and an outlet port that is opposite to the inlet port; said housing defining an interior chamber through which the fluid flows; a strainer basket that is disposed within the housing chamber and that is meant for the accumulation of debris; a lid that is disposed over the housing and covering the interior chamber; a gasket that is disposed between the housing and the lid; and pneumatic apparatus coupled to the interior chamber to provide a firm seal at the gasket.

In accordance with other aspects of the present invention further including a mechanical interlock mechanism so that the lid is secured to the housing; wherein the interlock mechanism is operable followed by the operation of the pneumatic apparatus; wherein the mechanical interlock mechanism includes a tab and slot arrangement; and wherein the tab and slot arrangement comprises at least one tab on an underside of the lid and at least one slot in the housing.

In accordance with another embodiment of the present invention there is provided a water filtration system comprised of: a regenerative filter that includes an array of juxtaposition filter elements that periodically have a particulate type of filtration media deposited thereon; a pump for providing water flow to the regenerative filter; a strainer that is disposed upstream of the pump; said strainer for capturing non-particulate matter and including a strainer housing and a strainer basket that is disposed within the strainer housing for retaining the non-particulate matter; said strainer further having an inlet port in the strainer housing for receiving filtration media that is subsequently deposited on all filter elements of the filter array.

In accordance with other aspects of the present invention the filtration media is a diatomaceous earth material; the filtration media is perlite; the filtration media is an amorphous volcanic glass material; the inlet port to the filter housing includes an inlet pipe that extends through a side wall of the filter housing; the inlet pipe is in direct communication with an interior of the filter housing; the strainer basket has an open input end into which the fluid flows from the housing inlet and opposed sidewalls that extend generally in a flow direction of the fluid; the strainer basket further includes an open output end that is comprised of a pair of tapered outlet walls that direct the fluid flow to an outlet port of the housing; the strainer housing has an end wall that has a series of through holes for the passage of fluid flow; and the tapered outlet walls each include a series of holes.

In accordance with still another embodiment of the present invention there is provided a system for applying a particulate type of filter media to an array of juxtaposition filter elements of a regenerative filter that includes filter elements that periodically have a filtration media deposited thereon; a pump for providing water flow to the regenerative filter; a strainer that is disposed upstream of the pump; said strainer for capturing non-particulate matter and including a strainer housing and a strainer basket that is disposed within the strainer housing for retaining the non-particulate matter; said strainer further having an inlet pipe in the strainer housing for receiving filtration media that is subsequently deposited on all filter elements of the filter array.

In accordance with still other aspects of the present invention the strainer housing has opposed end walls including an inlet port in one end wall and an outlet port in the opposed end wall; the inlet pipe for the filtration media is disposed in a side wall of the strainer housing; the filtration media is a diatomaceous earth material, perlite or an amorphous volcanic glass material; the strainer basket has an open input end into which the fluid flows from the housing inlet and opposed sidewalls that extend generally in a flow direction of the fluid; the strainer basket further includes an open output end that is comprised of a pair of tapered outlet walls that direct the fluid flow to an outlet port of the housing; the strainer housing has an end wall that has a series of through holes for the passage of fluid flow; and the tapered outlet walls each include a series of holes.

### BRIEF DESCRIPTION OF THE DRAWINGS

It should be understood that the drawings are provided for the purpose of illustration only and are not intended to define the limits of the disclosure. The foregoing and other objects and advantages of the embodiments described herein will become apparent with reference to the following detailed description when taken in conjunction with the accompanying drawings in which:

FIG. 1A is a top view of the housing;

FIG. 1B depicts the concept of the present invention of sealing the strainer housing without requiring several fasteners;

FIG. 2 is a plan view illustrating the strainer basket;

FIG. 3 illustrates an alternate embodiment of the tapered sidewalls of the basket;

FIG. 4 illustrates a second alternate embodiment of the tapered sidewalls;

FIG. 5 is an exploded perspective view of the strainer of the present invention, and including the strainer housing and basket;

FIG. 6 is a top perspective view of the top of the strainer housing with the basket in place;

FIG. 7 illustrates the underside of the lid with interlock bars disposed in a predetermined pattern;

FIG. 8 is a front perspective view of the same strainer housing;

FIG. 9 is a rear view of the strainer housing showing the lid in place;

FIG. 10A is a fragmentary view showing the tab end slot about to be engaged;

FIG. 10B is a fragmentary view showing the engagement between the tab and

slot;

FIG. 11 is a perspective view of an alternate embodiment of the present invention that employs a side inlet pipe for receiving filtration media;

FIG. 12 is a cross-sectional view taken along line 12-12 of FIG. 11;

FIG. 13 is a plan view of the embodiment of FIG. 11 with the lid partially cut away; and

FIG. 14 is a block diagram of the water delivery system.

### DETAILED DESCRIPTION

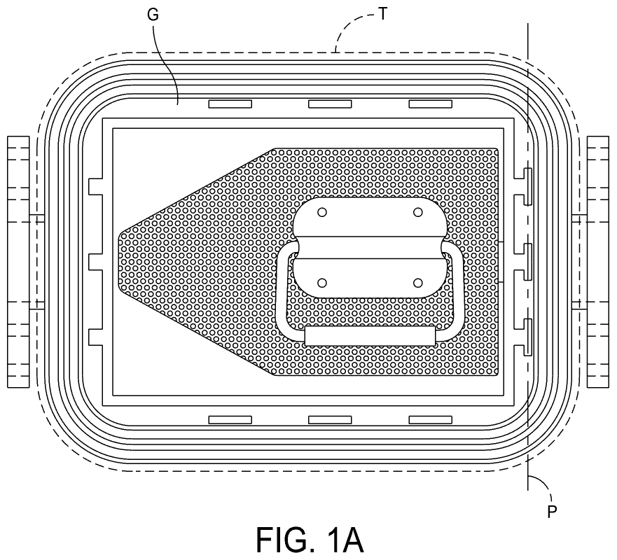

Reference is now made to FIGS. 1A and 1B. As has been indicated, rather than using several securing members to secure the strainer top, the top piece T is meant to slide into a position where it can then be pivoted against the top rim of the chamber and then locked in place. This occurs in a simple one step action without requiring multiple fasteners that have to be unthreaded and rethreaded.

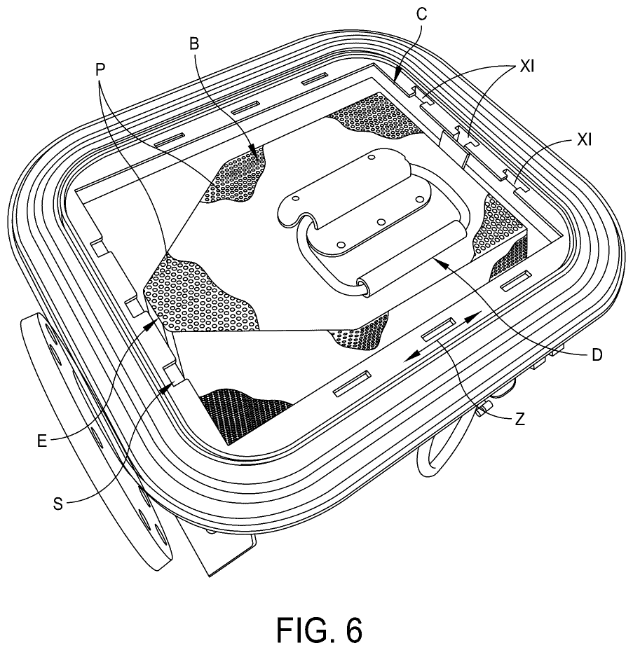

FIG. 1B depicts the concept of the present invention of sealing the strainer housing without requiring several fasteners. FIG. 1A is a top view of FIG. 1B. FIG. 1B shows both the housing H and the lid or cover L. FIG. 1B also illustrates the application of pneumatic force indicated by the input box R. A top piece T that seals the housing is slid into a slot in the cover L. The cover is meant to pivot at point P. FIG. 1B also shows the gasket G. The top piece T is meant to engage against the surface of the gasket G. Refer also to more detailed diagrams in FIGS. 6-9.

Although a pivot arrangement is illustrated in FIG. 1B, in an alternate embodiment of the present invention the cover can be constructed and arranged to be disposed substantially in parallel to the gasket G so that, rather than the pivot mechanism, some type of a slide mechanism is employed to move the cover against and away from the gasket G. In either embodiment it is pneumatic or hydraulic pressure that is employed in moving the cover from an open position to a closed position either by pivoting or a linear transition.

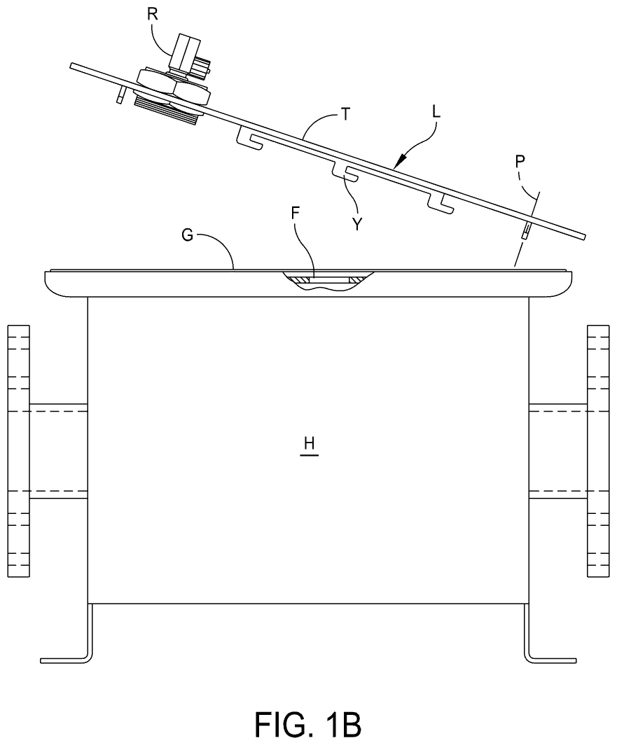

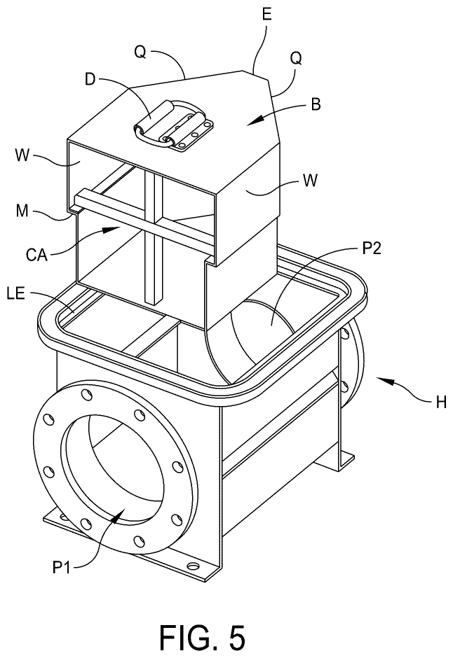

Reference is now made to FIGS. 2-5 to illustrate the construction of the strainer housing; and more particularly, the unique construction of the basket B. In FIGS. 2-5 the housing is shown at H having an inlet port P1 and an outlet port P2. Refer in particular to a more detailed construction in the exploded perspective view of FIG. 5.

The housing H defines an interior chamber through which the fluid flows through the basket B. The strainer basket has an open input end clearly depicted in FIG. 5. In this regard also refer in FIG. 5 to the use of a catcher CA that is meant to intercept certain items; particularly larger size items. The catcher CA is of cross-shape and is disposed at the open input end of the strainer basket; adjacent to the inlet port P1.

The strainer basket also includes opposed sidewalls W that extend generally in the same flow direction of the fluid. It is noted that the sidewalls W are provided with an indentation at M at opposed sides thereof. This indentation is meant to sit upon the ledge LE in the strainer housing as shown in FIG. 5. The strainer basket B further includes an output end depicted in the drawings as an end wall E that is disposed adjacent to the outlet port P2. In FIG. 2 the end wall E is illustrated as spaced from the port P2. However, the end wall E can also be disposed substantially directly at the port P2. The basket B is also provided with a handle D as illustrate in FIGS. 2 and 5.

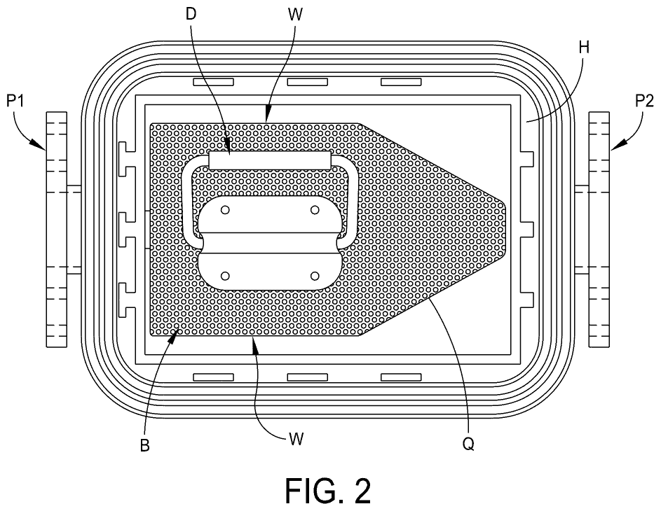

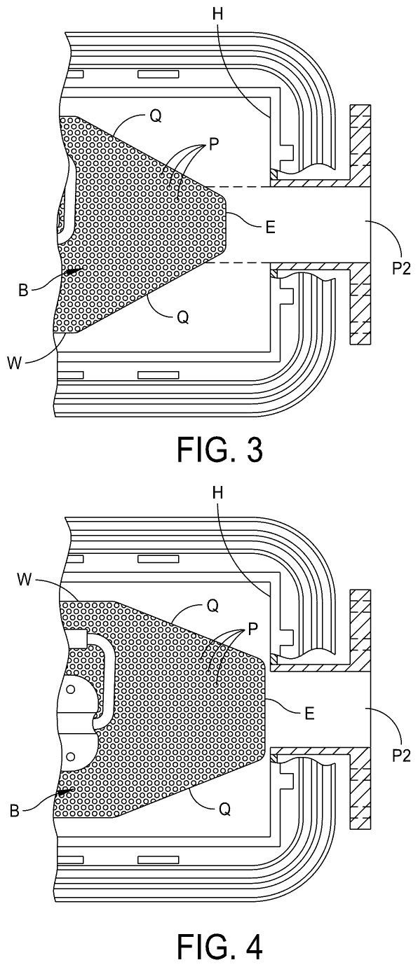

In FIG. 2 the end wall E is smaller than the diameter of the outlet port P2. Reference may now be made to FIGS. 3 and 4 that illustrate different relative dimensions regarding the end wall E and the outlet port P2. FIG. 3 illustrates the end wall E as being substantially the same as the diameter of the port P2. FIG. 4 illustrates the end wall E as being slightly greater than the diameter of the port P2. The sidewalls Q may be solid in construction but are preferably provided with perforations P such as illustrated in FIGS. 3 and 4. The end wall E is provided with perforations that enable the flow to continue to the outlet port P2. The walls Q taper toward the outlet port.

In accordance with one embodiment of the present invention there is provided the combination of using pneumatics; along with a mechanical interlock between the housing and lid. Thus, the strainer includes a mechanical interlock mechanism so that the lid is secured to the housing. The interlock mechanism is operable followed by the operation of the pneumatic apparatus. The mechanical interlock mechanism includes a tab and slot arrangement; wherein the tab and slot arrangement comprises at least one tab on an underside of the lid and at least one slot in the housing. Alternatively, the tab may be provided at the housing end and the slot at the lid end.

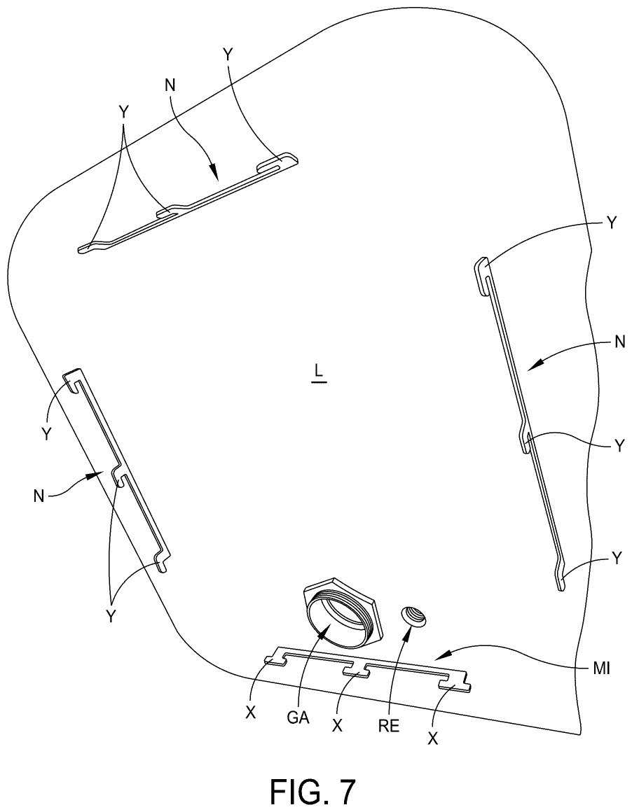

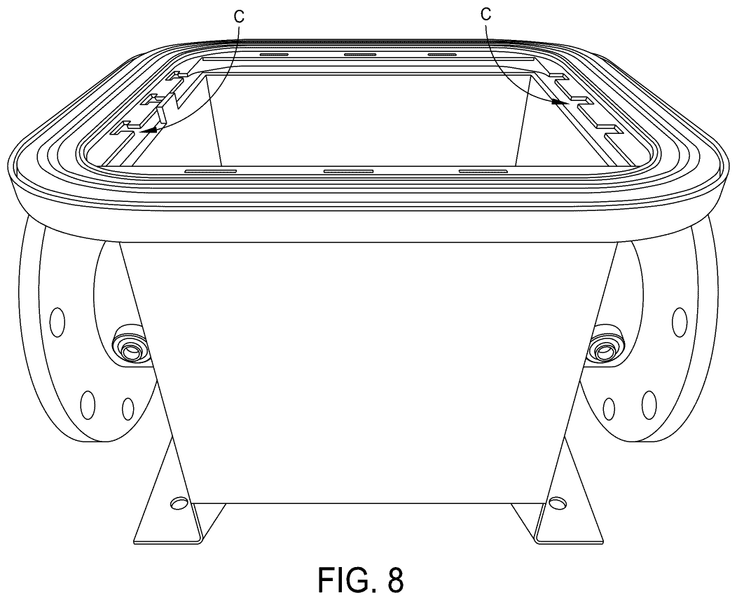

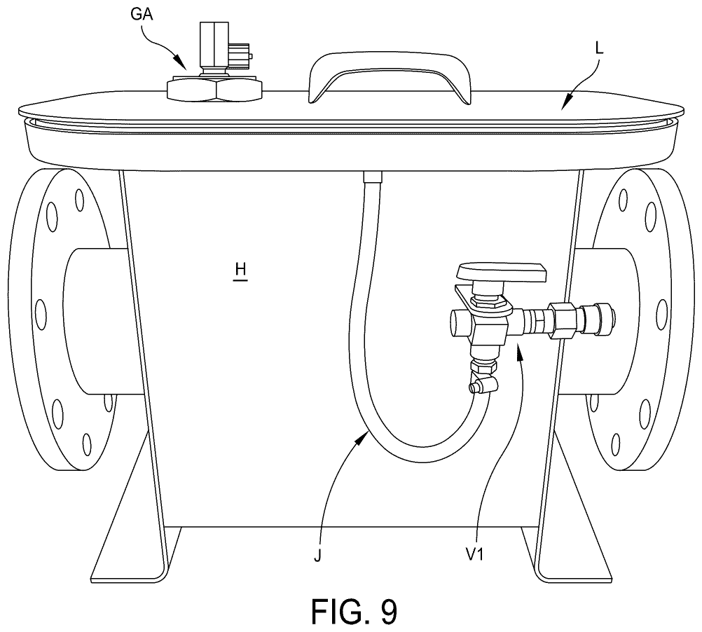

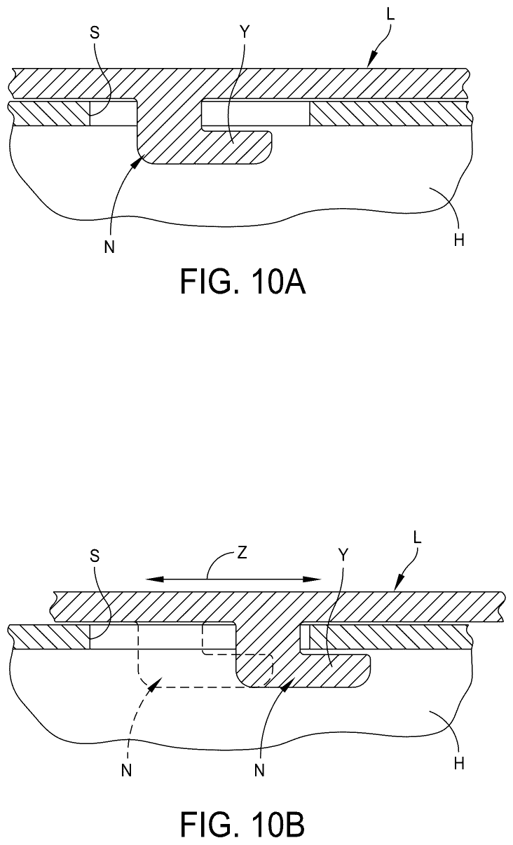

FIG. 6 is a top perspective view of the top of the strainer housing with the basket in place. FIG. 7 illustrates the underside of the lid with interlock bars disposed in a predetermined pattern. FIG. 8 is a front perspective view of the same strainer housing. FIG. 9 is a rear view of the strainer housing showing the lid in place. FIG. 10A is a fragmentary view showing the tab end slot about to be engaged. FIG. 10B is a fragmentary view showing the engagement between the tab and slot so as to provide a positive interlock.

FIGS. 6-9 show various views of the housing H and the lid L. Between those two members, a tab and slot arrangement is used to provide an interlock of the lid to the top of the housing. Refer in particular to FIG. 9 that shows the lid L assembled on the housing H. Regarding the interlocking of the lid with the housing, the underside of the lid has four tab bars N. Refer in particular to FIG. 7 which shows the underside of the lid L. Each of these tab bars has three spaced apart tabs. One of the tab bars identified as bar MI is provided with T-shaped tabs X. The other three tab bars N each have L-shaped tabs Y.

Reference may now be made to FIG. 6 which shows the slots in the housing. There are provided a series of slots S that are substantially rectangular in shape. At one end of the housing there is provided three T-shaped slots X1. The tabs W illustrated in FIG. 7 are meant to engage with the slots S shown in FIG. 6. At the same time, the tab bar WI with the T-shaped tabs X are meant for engagement in the slots X1 shown in FIG. 6. The interlocking is provided by moving the lid relative to the housing in the direction of arrow Z in FIG. 6 in order to complete the interlock. FIG. 7 also shows the connection at GA for pneumatic coupling. Also in FIG. 7 RE is directed at a relieve port.

Reference is also made in FIG. 6 to the inclusion of the basket B within the housing. FIG. 6 illustrates the end wall E of the basket B that may be symmetrically aligned with the output port of the housing. In an alternate embodiment of the present invention the end wall E may be slightly off center of the output port of the housing. There are preferably provided perforations P on the top wall of the basket as well as on the end wall. The tapered walls Q may be provided with perforations or may be solid.

Regarding the pneumatic operation, reference may be made to the rear view depicted in FIG. 9. This shows a valve V1. This is the location where the pneumatic pressure is applied. FIG. 9 also shows a hose J that connects the valve V1 into the housing H. This connection couples to the channel C. In this regard refer also to FIGS. 6 and 8 that show the location of an inner channel C where the pneumatic pressure is exerted.

Finally, fragmentary perspective views are illustrated in FIGS. 10A and 10B. FIG. 10A illustrates an initial position of the lid and housing where the tab end slot is about to be engaged. On the other hand, in FIG. 10B the tab is illustrated as engaged with the slot in order to interlock the lid and housing.

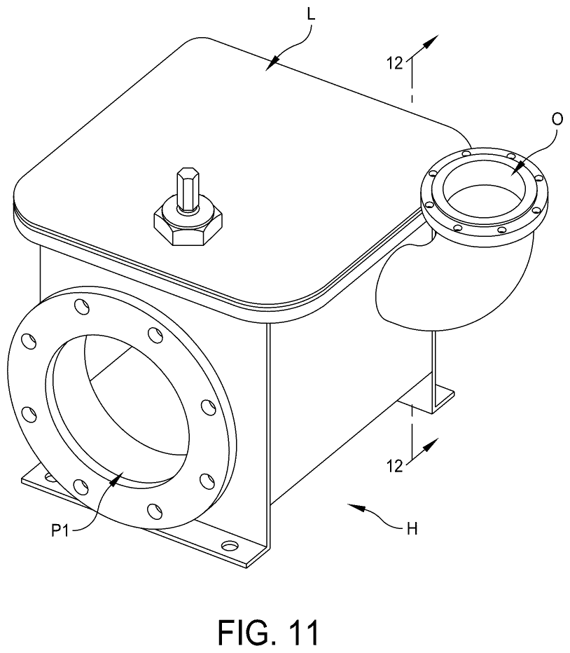

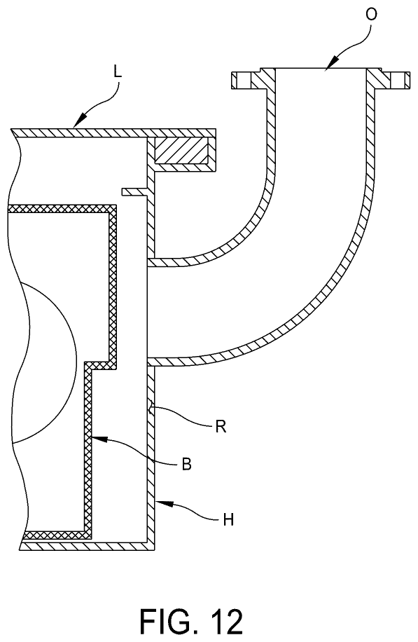

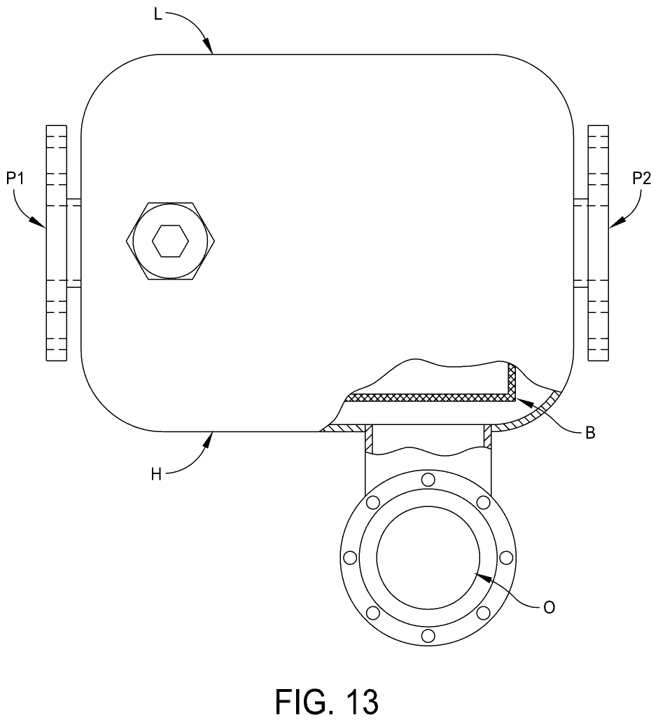

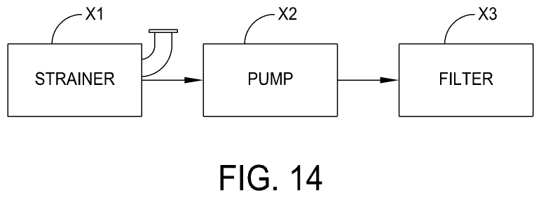

Reference is now made to a further embodiment of the present invention illustrated in FIGS. 11-14. In this embodiment the basic strainer housing H and basket B are substantially the same as described in FIGS. 1-10. This embodiment further adds a side port or pipe O. This side port is for the introduction of filtration media that is to be subsequently deposited on all of the filter elements of the filter array. Regarding the filter element itself, reference can be made to U.S. Pat. No. 11,065,566 which describes the regenerative filter that may be employed from the system of the present invention. In this regard refer also to the block diagram of FIG. 14 that shows the strainer at X1, the pump at X2 and the filter at X3. As noted from FIG. 14 and regarding the direction of flow, the strainer will capture certain contaminants to prevent their entry to the pump X2. The pump X2 then controls the flow to the filter X3.

With further reference to FIGS. 11-13, it is noted that there is a side inlet pipe or port into which the filtration media is deposited. The filtration media may be a diatomaceous earth material, a perlite, and amorphous volcanic glass material or any other appropriate filtration media. As illustrated in the drawings, the pipe O is in a side wall R. By providing the port O at the strainer, this avoids the complexities associated with providing a porting arrangement for introducing the filtration media directly at the filter.

Having now described a limited number of embodiments of the present invention, it should now be apparent to those skilled in the art that numerous other embodiments and modifications thereof are contemplated as falling within the scope of the present invention, as defined by the appended claims.

1. A water filtration system comprised of:
a regenerative filter that includes an array of juxtaposition filter elements that periodically have a particulate type of filtration media deposited thereon;
a pump for providing water flow to the regenerative filter;
a strainer that is disposed upstream of the pump;
said strainer for capturing non-particulate matter and including a strainer housing and a strainer basket that is disposed within the strainer housing for retaining the non-particulate matter;
said strainer further having an inlet port in the strainer housing for receiving filtration media that is subsequently deposited on all filter elements of the filter array.

2. The water filtration system of claim 1 wherein the filtration media is a diatomaceous earth material.

3. The water filtration system of claim 1 wherein the filtration media is perlite.

4. The water filtration system of claim 1 wherein the filtration media is an amorphous volcanic glass material.

5. The water filtration system of claim 1 wherein the inlet port to the filter housing includes an inlet pipe that extends through a side wall of the filter housing.

6. The water filtration system of claim 5 wherein the inlet pipe is in direct communication with an interior of the filter housing.

7. The water filtration system of claim 1 wherein said strainer basket has an open input end into which the fluid flows from the housing inlet and opposed sidewalls that extend generally in a flow direction of the fluid.

8. The water filtration system of claim 7 wherein said strainer basket further includes an open output end that is comprised of a pair of tapered outlet walls that direct the fluid flow to an outlet port of the housing.

9. The water filtration system of claim 1 wherein the strainer housing has an end wall that has a series of through holes for the passage of fluid flow.

10. The water filtration system of claim 9 wherein the tapered outlet walls each include a series of holes.

11. A system for applying a particulate type of filter media to an array of juxtaposition filter elements of a regenerative filter that includes filter elements that periodically have a filtration media deposited thereon;
a pump for providing water flow to the regenerative filter;
a strainer that is disposed upstream of the pump;
said strainer for capturing non-particulate matter and including a strainer housing and a strainer basket that is disposed within the strainer housing for retaining the non-particulate matter;
said strainer further having an inlet pipe in the strainer housing for receiving filtration media that is subsequently deposited on all filter elements of the filter array.

12. The system of claim 11 wherein the strainer housing has opposed end walls including an inlet port in one end wall and an outlet port in the opposed end wall.

13. The system of claim 12 wherein the inlet pipe for the filtration media is disposed in a side wall of the strainer housing.

14. The system of claim 11 wherein the filtration media is a diatomaceous earth material.

15. The system of claim 11 wherein the filtration media is perlite.

16. The system of claim 11 wherein the filtration media is an amorphous volcanic glass material.

17. The system of claim 11 wherein said strainer basket has an open input end into which the fluid flows from the housing inlet and opposed sidewalls that extend generally in a flow direction of the fluid.

18. The system of claim 17 wherein said strainer basket further includes an open output end that is comprised of a pair of tapered outlet walls that direct the fluid flow to an outlet port of the housing.

19. The system of claim 11 wherein the strainer housing has an end wall that has a series of through holes for the passage of fluid flow.

20. The system of claim 19 wherein the tapered outlet walls each include a series of holes.
